(19) United States
(12) Patent Application Publication
(10) Pub. No.: US 2013/0196847 A1
(43) Pub. Date: Aug. 1, 2013

(54) CATALYST CARRIER FOR OLEFIN POLYMERIZATION, SOLID CATALYST COMPONENT AND CATALYST

(71) Applicants: Zhong Tan, Beijing (CN); Xiudong Xu, Beijing (CN); Li'an Yan, Beijing (CN); Qilong Zhou, Beijing (CN); Weiwei Song, Beijing (CN); Shanshan Yin, Beijing (CN); Jinhua Yu, Beijing (CN); Fengkui Li, Beijing (CN); Ying Wang, Beijing (CN); Chunhong Ren, Beijing (CN)

(72) Inventors: Zhong Tan, Beijing (CN); Xiudong Xu, Beijing (CN); Li'an Yan, Beijing (CN); Qilong Zhou, Beijing (CN); Weiwei Song, Beijing (CN); Shanshan Yin, Beijing (CN); Jinhua Yu, Beijing (CN); Fengkui Li, Beijing (CN); Ying Wang, Beijing (CN); Chunhong Ren, Beijing (CN)

(21) Appl. No.: 13/824,127

(22) PCT Filed: Sep. 9, 2011
(86) PCT No.: PCT/CN2011/001536

§ 371 Date: Mar. 15, 2013

(30) Foreign Application Priority Data
Sep. 16, 2010 (CN) 201010283034.8
Oct. 25, 2010 (CN) 201010522125.2

(51) Int. Cl. C08F 4/623; C08F 4/642

(52) U.S. Cl. CPC C08F 4/623; C08F 4/642
USPC 502/127; 502/439; 568/851

(57) ABSTRACT

The invention relates to a dialkoxyl magnesium carrier, which is a product produced by a reflux reaction of magnesium, an alcohol and mixed halogenated agents under an inert atmosphere. The mixed halogenated agents are iodine and magnesium chloride, and the weight ratio between iodine and magnesium chloride is 0.05:1-1:0.01. The dialkoxyl magnesium carrier is spheroid with uniform particle size distribution, excellent particle morphology and high bulk density. A solid catalyst component and a catalyst based on this carrier for olefin polymerization are also provided, and olefin polymers having a wide molecular weight distribution, good stereoregularity, excellent particle morphology and a low content of fine powders can be obtained.

### TECHNICAL FIELD

The present invention relates to a catalyst carrier for olefin polymerization, especially relates to a dialkoxy magnesium carrier. The present invention also relates to a solid catalyst component comprising said spherical dialkoxy magnesium carrier and a polymerization catalyst.

### TECHNICAL BACKGROUND

Generally, the Ziegler-Natta catalyst including titanium compounds and organo-aluminum compounds is used to obtain olefin polymers in the olefin polymerization field. For example, CN85100997A and CN1453298A disclose that a catalyst comprising a solid catalyst component mainly consisting of titanium, magnesium, chlorine and electron donor compounds, an organo-aluminum compound as a cocatalyst and an organo-silicon compound as an agent for improving stereoregularity, is used in the preparation of polypropylene to obtain propylene polymer. Recently, the researches for catalysts mainly focus on the following aspects, improving the polymerization activity of catalysts, improving the stereoregularity of polyolefins, improving the hydrogen response of catalysts, improving the particle morphology of olefin polymers, reducing the residual chloride in the polymers and so on.

The propylene polymers obtained by the supported catalyst component with dialkoxy magnesium as a carrier possess excellent performances such as excellent particle morphology, a low content of fine powders, good stereoregularity and so on. To obtain such an excellent catalyst component for olefin polymerization, first of all, the dialkoxy magnesium carrier with excellent performances should be prepared.

The known preparation methods for spherical dialkoxyl magnesium mainly contain the following kinds, the first method is to react an alcohol with metal magnesium to prepare dialkoxyl magnesium and then adjust the size of particles by mechanical pulverizing; the second preparation method is to control the final addition ratio of magnesium/ethanol within 9/1 to 1/15 in the reaction of metal magnesium and ethanol, and carry out the reaction intermittently or continuously when ethanol and magnesium are refluxed in ethanol (JP3 (1991)-74341); the third preparation method is to spray dry the ethanol solution of magnesium carboxylate after carboxylated, and then make decarboxylation to obtain round fine particles (JP6 (1994)-87773); the fourth preparation method is to react metal magnesium with ethanol in the coexistence of saturated hydrocarbons (JP63 (1988)-4815).

In the first and second methods, the shapes of particles are pulverized and destroyed. It is very difficult to obtain the particles with well surface morphology and particle size distribution, sometimes at the expense of reducing the output rate. In the third and fourth methods, other raw materials are also needed except Mg and ROH, and the operations are also complex. Each of the above methods has deficiency.

CN1875038A discloses a kind of spherical particles comprising the mixture of hydrocarbyloxy magnesium or hydroxyl magnesium, said spherical particles having a dumping cone highness less than 17 mm, and it discloses the use of the mixture of methanol, ethanol and propanol and iodine to prepare spherical particles in the examples. When using such a method to prepare products with a large particle size, the particle size distribution will be wider, and iodine is entirely used as a halogenated agent, and the cost of raw materials is high, which is not beneficial for large-scale industrial application.

There are various researches on preparing an olefin polymerization catalyst component with dialkoxyl magnesium as a carrier. EP0459009 discloses a catalyst component for olefin polymerization. The preparation method is as follows: diethoxy magnesium is dispersed in alkylbenzene to form a suspension; the suspension then touches with titanium tetrachloride and the dichloride of phthaloyl in 80-125° C.; after being washed with alkylbenzene, finally the catalyst component containing titanium is obtained. Although the catalyst obtained by such catalyst component has a high activity and a long activity endurance in polymerization, the bulk density of propylene polymers is relatively low.

EP0811639 mainly discloses a solid catalyst component for olefin polymerization, which is prepared by the reaction of a titanium halide, an aryl dicarboxylic diester and an alkoxy magnesium. A solid catalyst component can be obtained by controlling the indexes such as the bulk density of the alkoxy magnesium and the average particle size and controlling the rate of heating the temperature at which the titanium halide first touches with the alkoxy magnesium to the temperature of the reaction (the heating rate is controlled at 0.5 to 20° C./min). Then a polyolefin with high isotacticity and high bulk density can be obtained, but the content of fine powders therein is high.

In CN101054424A, the prepared dialkoxy magnesium is suspended in toluene, titanium tetrachloride is added after the temperature is decreased to 0° C., then the temperature is increased and electron donors are added. Toluene is added to wash the product after full reaction, then titanium compound is used for treating, and finally hexane is used for washing. The polymerization activity of the solid catalyst component is relatively high, the sphericity is good, but the particle size distribution is not concentrated.

### SUMMARY OF INVENTION

The present invention aims to overcome the defects of the prior art and provide a spherical-like dialkoxy magnesium carrier with well performances. The present invention also provides a solid catalyst component and a catalyst based on said carrier to be used in olefin polymerization, so that olefin polymers with a wider molecular weight distribution, well stereoregularity, well particle morphology and a low content of fine powders can be obtained.

The present invention provides a dialkoxy magnesium carrier, which is the product prepared by the reflux reaction of magnesium, alcohols and mixed halogenated agents in inert atmosphere, wherein said mixed halogenated agents are iodine and magnesium chloride, and the weight ratio of iodine and magnesium chloride is 1:0.05 to 0.05:1.

In the above dialkoxy magnesium carrier, the weight ratio of iodine and magnesium chloride is preferably 0.1:1 to 1:0.02. As the chemical activity of magnesium is high, its affinity with oxygen is big, oxide films such as magnesium oxide and magnesium hydroxide will be generated after it is placed in air. When the halogens or halides are added into alcohols, the oxide films on the surface of magnesium can be removed under mild conditions, so that the reaction of alcohol and magnesium can be promoted. In the present invention, only simply mixing the halogenated agents cannot control the particle morphology of dialkoxy magnesium. Through in-depth study, the inventor finds that the reaction rate of alcohols and magnesium can be effectively controlled by selecting the mixed halogenated agents comprising halogens and halides and controlling the ratio of the halogens and the halides, and only when the ratio of the halogens and the halides is appropriate, the particle morphology of dialkoxy magnesium can be maintained. In the mixed halogenated agents, the acidities of the halogens and the halides are that one is strong, and the other is weak. At first, the halogens play the main role in removing the oxide films, and then the halides work together with the pre-added halide, so that the reaction rate can be effectively controlled. At the same time, the price of halogens is much higher than that of halides, the required cost would be lower when the same amounts of halides are used. The mixed halogenated agents can be used in a pure state or a solution state. They can be added into the reaction system respectively, or added after being partially or entirely mixed. The mixed halogenated agents can be the combination of other halogens and halides. The unlimited selection of said halogens and halides can be I₂, Br₂, Cl₂, MgBr₂, Kl, MgI₂, CaCl₂, CaBr₂, CaI₂, HgBr₂, HgI₂, ethoxy magnesium iodide, methoxy magnesium iodide, isopropyl magnesium iodide, hydrogen chloride, chloroacetyl chloride and so on, wherein, the combination of iodine and magnesium chloride is preferred.

In the above carrier, the molar ratio of said magnesium and the halogen atoms in said mixed halogenated agents is 1:0.00024:0.2, preferably 1:0.0014:0.08. It is found by experiments that the adding amount of halogen atoms will affect the particle morphology and particle size of the final dialkoxy magnesium. When the amount of used halogen atoms is too small, the particle morphology of the obtained dialkoxy magnesium is poor, and if the dosage of halogen atoms is too big, not only the cost for preparing dialkoxy magnesium will increase, but also the particle size of dialkoxy magnesium will be uneven, and the reaction is difficult to control.

In said dialkoxy magnesium carrier, the weight ratio of alcohols and magnesium is 4:1-50:1, preferably 6:1-25:1. Said alcohols are mixed alcohols, which can better adjust the reaction rate and control the reaction process. The kinds and ratio of mixed alcohols can be changed according to the requirements of the product structures. Ethanol is the main component and the other alcohols are the minor components in the mixed alcohols. There is no specific limitation on the content of water in the alcohols used in the present invention, but in order to make the obtained dialkoxy magnesium with better performances, the content of water is required to be as low as possible. Generally, the content of water in the alcohols is controlled at no more than 1000 ppm, preferably no more than 200 ppm.

Said alcohols comprise ethanol and at least one selected from C₆-C₁₁ alcohols, comprising n-heptanol, 2-ethyl hexanol, n-hexanol, n-heptanol, n-octanol, n-nonanol, n-decanol, 2-hexanol, 2-heptanol, 2-octanol, 2-nonanol, 2-decanol, 2-ethyl butanol, 2-ethyl hexanol, 4-methyl-2-pentanol, 3,3,5-trimethyl pentanol, 4-methyl-3-heptanol, benzyl alcohol, 2-phenyl ethanol, 1-phenyl-1-propanol and so on, preferably ethanol and at least one selected from C₆-C₈ alcohols, more preferably ethanol and 2-ethyl hexanol, and in the finally obtained carrier, the content of ethoxy magnesium is equal to or higher than 80 wt %, and the content of 2-ethyl hexyloxy magnesium is 0.01 to 20 wt %.

Said alcohols further comprise ethanol and at least one selected from C₁-C₅ lower alcohols, including not ethanol but rather methanol, n-propanol, n-butanol, n-pentanol, 2-propanol, 2-butanol, 2-pentanol, ethylene glycol, glycerin and so on, preferably ethanol and isopropanol, when the content of ethoxy magnesium is equal to or higher than 80 wt %, and the content of isopropoxy magnesium is 0.01 to 20 wt % in the obtained carrier.

Said alcohols preferably comprise ethanol, at least one selected from C₆-C₁₁ alcohols and at least one selected from C₁-C₅ lower alcohols, not including ethanol. More preferably, said alcohols comprise ethanol, 2-ethyl hexanol and isopropanol. The three alcohols can be added at the same time, or added respectively in a certain order, on which there is no specific limitation. In the finally obtained carrier, the content of ethoxy magnesium is equal to or higher than 80 wt %, the content of 2-ethyl hexyloxy magnesium is 0.01 to 1.9.9 wt % and the content of isopropoxy magnesium is 0.01 to 19.9 wt %.

A. Said dialkoxy magnesium carrier is spherical-like, and the average particle size is 5 to 150 μm, preferably 8˜150 μm, further preferably 8 to 100 μm. In a specific example, the average particle size is 10 to 80 μm. The particle size distribution index SPAN is less than 1.1, preferably less than 1.05, wherein the calculation formula of SPAN is as follows,

SPAN=(D₉₀−D₁₀)/D₅₀

In the formula, D₉₀ shows the particle size corresponding to 90% cumulative weight fraction, D₁₀ shows the particle size corresponding to 10% cumulative weight fraction, and D₅₀ shows the particle size corresponding to 50% cumulative weight fraction.

In the present invention, the used magnesium is magnesium metal. As long as its reaction performance is good, it can be in any shapes, including granular, ribbon shaped or powdered ones, in order to make the average particle size of the generated dialkoxy magnesium within a suitable range and the particle morphology to be good, the preferable method is to require the magnesium metal to be spherical particles with an average size of 10-360 μm, more preferably 50˜300 μm, which can maintain the reaction performance to be relatively uniform.

In addition, as the chemical activity of magnesium is strong, the oxide films such as magnesium oxide and magnesium hydroxide are generally formed on the surface of magnesium, but there is no specific limitation on the oxide films on the surface of magnesium metal.

Said inert atmosphere in the present invention comprises nitrogen atmosphere, argon atmosphere and so on, preferably nitrogen atmosphere.

The preparation method of said dialkoxyl magnesium carrier comprises the following steps: magnesium and said alcohols are used as raw materials, and the reflux reaction is carried out in the presence of said mixed halogenated agents to prepare spherical-like particle dialkoxy magnesium under an inert atmosphere.

An inert organic solvent can be used in the preparation process according to the situation. In the present invention, said inert solvent can be selected from at least one of C₆-C₁₀ alkanes or aromatics, preferably selected from at least one of hexane, heptanes, octane, decant, benzene, toluene, xylene or their derivations, and so on.

In the above preparation process, the adding order of each reactant can be determined according to actual needs. Specifically, there is no particularly limitation on the adding method of halogenated agents. It can be added after being dissolved in alcohols or directly added into the magnesium and alcohols in the solid state or the liquid state; the method of adding the alcohol solution of halogenated agents dropwise when heating the solution of magnesium metal and alcohol can also be used, after which the reaction for preparing carrier can be carried out.

As to the addition of magnesium, alcohols, halogenated agents and the inert solvent, they can be added in one time or successively. Adding the raw materials successively can prevent the generation of a large amount of hydrogen instantaneously and the droplet of alcohols or halogenated agents resulted from the generation of a large amount of hydrogen instantaneously, so such feeding method is preferred when taking the security and reaction uniformity into account. The number of feeding times can be determined by the reactor scale and dosage of each material.

Said reaction is carried out between 0° C. and the reflux temperature of the reaction system in the above preparation steps for the dialkoxy magnesium carrier. The minor changes of reaction pressure will change the reflux temperature. The higher the reaction temperature is, the more quickly the reaction is carried out. The reaction temperature during the reaction can also be changed. The particle size and particle morphology can be changed by selecting different reaction temperatures. Said reaction time is 2-30 h. In the actual operation, when the emission of hydrogen stops, the reaction can be judged as having stopped accordingly.

After the completion of reaction, the obtained final product can be saved after being dried or by being suspended in the inert diluents used for preparing the solid catalyst component in the next step.

The present invention also provides a solid catalyst component for olefin polymerization, wherein said catalyst component comprises the reaction products of the following components in an inert solvent,

a) said dialkoxy magnesium carrier;
b) titanium compounds, selected from at least one of the compounds as shown in Formula Ti(OR)₄₋ₙXₙ, wherein R is selected from C₁-C₁₄ aliphatic hydrocarbyi or aromatic hydrocarhyl groups, X is a halogen atom, and n is an integer selected from 0 to 4. When n is equal to or higher than 2, the existing plurality of Rs can be same with or different form each other;
c) electron donor compounds, selected from C₁-C₄ alkyl esters of saturated aliphatic carboxylic acids, C₇-C₈ alkyl esters of aromatic carboxylic acids, C₂-C₆ aliphatic ethers, C₃-C₄ cycloethers, C₃-C₆ saturated aliphatic ketones and/or diol ester compounds selected from those as shown in Formula (I);

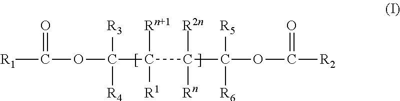

wherein R₁-R₆ and R¹-R²ⁿ groups, the same with or different from each other, can be hydrogen atom, halogen atom, substituted or unsubstituted straight chain or branched chain C₁-C₂₀ alkyl, C₃-C₂₀ cycloalkyl, C₆-C₂₀ aryl, C₂-C₂₀ alkaryl, C₇-C₂₀ aralkyl, C₂-C₁₀ alkenyl, C₁₀-C₂₀ fused ring aryl or ester group; R₁ and R₂ are not hydrogen atoms; R₃-R₆ and R¹-R²ⁿ groups can optionally comprise one or more heteroatoms as the substituent of carbon and/or hydrogen atoms, said heteroatoms selected from nitrogen, oxygen, sulfur, silicon, phosphorus and halogen atoms; one or more of R₃-R₆ and R¹-R²ⁿ groups can optionally form a ring with each other; n is an integer selected from 0 to 10.

The electron donor compounds as shown in Formula (I) preferably comprises the compounds as shown in Formula (II)

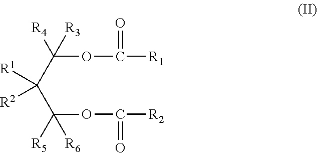

wherein R₁-R₆ and R¹-R² groups, the same with or different from each other, can be hydrogen atom, halogen atom, straight chain or branched chain C₁-C₂₀ alkyl, C₃-C₂₀ cycloalkyl, C₆-C₂₀ aryl, C₇-C₂₀ alkaryl or C₇-C₂₀ aralkyl group.

In the above solid catalyst component, the dosage of titanium compounds is 0.5 to 100 mol, preferably 1 to 50 mmol, based on per molar of dialkoxy magnesium compounds.

In the Formula of said titanium compounds in the above solid catalyst component, X is preferably the chlorine atom or the bromine atom, more preferably the chlorine atom; the structure of R has many possibilities, comprising saturated or unsaturated group, straight chain group or branched chain group or cyclic chain group. The preferable C₁-C₁₄ group can be alkyl, alkenyl, cycloalkenyl or aralkyl group, especially C₁-C₁₄ straight chain or branched chain alkyl group. When n is equal to or higher than 2, the existing plurality of Rs can be the same with or different form each other. The specific examples of R are selected from at least one of methyl, ethyl, n-propyl, isopropyl, allyl, n-butyl, sec-butyl, isohutyl, n-pentyl, n-hexyl, n-heptyl, n-octyl, n-decyl, allyl, butenyl, cyclopentyl, cyclohexyl, cyclohexenyl, benzyl, phenyl, tolyl and phenylethyl groups. Said titanium compounds are selected from at least one of tetraalkoxy titanium, titanium tetrahalide, alkoxytitanium trihalide, dialkoxy titanium dihalide and trialkoxy titanium halide. More specifically, said tetraalkoxy titanium is selected from at least one of tetramethoxy titanium, 1.0 tetraethoxy titanium, tetrapropoxy titanium, tetra-iso-propoxy titanium, tetra-n-butoxy titanium, tetra-iso-butoxy titanium, tetracyclohexyloxy titanium and tetraphenoxy titanium. Said titanium tetrachloride is selected from at least one of titanium tetrachloride, titanium tetrabromide and titanium tetraiodide. Said alkoxy titanium trichloride is selected from at least one of methoxy titanium trichloride, ethoxy titanium trichloride, propoxy titanium trichloride, n-hutoxy titanium trichloride and ethoxy titanium tribromide. Said dialkoxy titanium dichloride is selected from at least one of dimethoxy titanium dichloride, diethoxy titanium dichloride, di-n-propoxy titanium dichloride, di-iso-propoxy titanium dichloride and diethoxy titanium dibromide, Said trialkoxy titanium chloride is selected from at least one of trimethoxy titanium chloride, triethoxy titanium chloride, tri-n-propoxy titanium chloride, tri-iso-propoxy titanium chloride. Titanium tetrahalide is preferred, and titanium tetrachloride is particularly preferred.

In the above solid catalyst component, the dosage of electron donor compounds is generally 0.005 to 10 mol, preferably 0.01 to 1 mol, based on per molar of dialkoxy magnesium compounds. Said electron donor compounds can be used in combination with one another.

In the above catalyst component, the specific examples of C₁-C₄ alkyl esters of saturated aliphatic carboxylic acids, C₇-C₈ alkyl esters of aromatic carboxylic acids, C₂-C₆ aliphatic ethers, C₃-C₄ cycloethers, C₃-C₆ saturated aliphatic ketones comprise methyl formate, ethyl acetate, butyl acetate, diisobutyl phthalate, din-butyl phthalate, diisooctyl phthalate, 1,3-diamyl phthalate, ethyl ether, hexyl ether, tetrahydrogen furan (THF), acetone, methyl iso-butyl ketone and so on, preferably at least one of din-butyl phthalate, diisobutyl phthalate and 1,3-diamyl phthalate.

In the above solid catalyst component, said diol ester compound electron donors are disclosed in CN1436766 and CN1436796A. The related disclosures in the above patents are totally introduced into the present invention as a reference. Said diol ester compounds as shown in Formula (II) comprise 2-ethyl-1,3-glycol dibenzoate, 2-propyl-1,3-glycol dibenzoate, 2-isopropyl-2-isoamyl-1,3-glycol dibenzoate, 1,3-butanediol dimethyl benzoate, 2-methyl-1,3-butanediol dim-chloro benzoate, 2,3-dimethyl-1,3-butanediol dibenzoate, 1,3-pentanediol pivalate, 2,4-pentanediol dibenzoate, 2-methyl-1,3-pentanediol benzoic cinnamate, 2,2-dimethyl-1,3-pentanediol dibenzoate, 2,4-heptanediol benzoate, 2-methyl-3,5-heptanediol dibenzoate and so on, preferably at least one of 2,4-pentanediol dibenzoate and 4-ethyl-3,5-heptanediol dibenzoate.

In the above solid catalyst component, the inert solvent is used to disperse and dilute the materials so as to make the liquids to react under a good stirring state, and it can also eliminate partial static electricity and make a certain effect on maintaining well particle morphology. The dosage of said inert diluents is 0.5 to 100 mol, preferably 1 to 50 mol, based on per molar of dialkoxy magnesium compounds. The inert solvent herein is preferably toluene.

The above solid catalyst component for olefin polymerization using spherical-like dialkoxy magnesium as a carrier can be prepared by the following steps. The above dialkoxy magnesium compounds react with titanium compounds and electron donor compounds in the presence of an inert solvent to obtain the solid, and then the above solid is washed with an inert solvent to obtain the solid catalyst component.

In the above method, said dialkoxy magnesium, titanium compound, inert solvent and electron donor compound are preferably to react on the following conditions, Said reaction temperature is generally −40 to 200° C., preferably −20 to 150° C.; said reaction time is generally 1 min to 20 h, preferably 5 min to 8 h.

In the above method, there is no specific limitation on the addition order of each reactant. For example, each component can mix with one another in the presence of the inert solvent, or each component can be previously diluted by the inert solvent before the mixing. There is no specific limitation on the number of times of mixing, which can be once or many times.

The inert solvent for the above washing is preferably hexane. There is no specific limitation on the washing method, but decantation, filtration and so on are preferred. There is no specific limitation on the dosage of the inert solvent, the washing time and the number of washing times. Based on per molar of dialkoxy magnesium compounds, 1 to 1000 mol, preferably 10 to 500 mol of the solvent is generally used to wash for 1 to 24 h, preferably 6 to 10 h. in addition, it is preferred to stir under washing operation from the point of washing uniformity and washing efficiency.

Said solid catalyst component can be saved in dry condition or in an inert solvent.

The present invention also provides a catalyst for olefin polymerization comprising

a) the above solid catalyst component;
b) organoaluminum compound, selected from at least one of the compounds as shown in Formula AlRₙX₃₋ₙ, wherein R is selected from hydrogen atoms and C₁-C₂₀ hydrocarbyl groups, X is the halogen atom, and n is an integer selected from higher than 0 to 3;
c) optional organo-silicon compound, whose formula is R₁R₂Si(OR′)₂, wherein R₁ and R₂ the same with or different from each other, can be C₁-C₂₀ alkyl, cycloalkyl or aryl group, and R′ is C₁-C₄ alkyl group.

In the above catalyst for olefin polymerization, the specific examples of said organoaluminum compound comprise alkyl aluminum halides, such as trimethyl aluminum, triethyl aluminum, triisobutyl aluminum, trioctyl aluminum, diethyl aluminum chloride, diisobutyl aluminum chloride, ethyl aluminum dichloride and so on preferably triethyl aluminum or triisobutyl aluminum. The ratio of said organoaluminum compounds and said solid catalyst component is 5-5000:1, preferably 20-500:1, based on the molar ratio of aluminum and titanium.

In the above catalyst for olefin polymerization, the ratio of said organosilicon compound and organoaluminum compound is 2-100:1, preferably 5-50:1, based on the molar ratio of aluminum and silicon. The specific examples of said organosilicon compound comprise trimethyl methoxy silane, trimethyl ethoxy silane, trimethyl phenoxy silane, dimethyl dimethoxy silane, dimethyl diethoxy silane, cyclohexyl methyl diethoxy silane, methyl cyclohexyl dimethoxy silane, diphenyl dimethoxy silane, diphenyl diethoxy silane, phenyl triethoxy silane, phenyl trimethoxy silane, vinyl trimethoxy silane and so on, preferably cyclohexyl methyl dimethoxy silane or diisopropyl dimethoxy silane.

By using the above provided carrier, solid catalyst component and catalyst, the catalyst in the present invention can be used for olefin polymerization, comprising homopolymerization and copolymerization, said olefin containing propylene, ethylene and so on, whose polymerization activity is high and through which olefin polymers with stereoregularity and good particle morphology can be obtained. Ethylene-propylene copolymers with high ethylene content can be prepared according to the present invention. As the stereoregularity is good when said catalyst is used in propylene homopolymerization, the prepared copolymers are suitable to be used as the raw material for impact resistant products with balanced physical properties such as rigidness and impact resistance.

The present invention provides a spherical-like dialkoxy magnesium carrier with good performances. Iodine and magnesium chloride are used as halogenated agents. The dosages of halogenated agents and mixed alcohols are small, and the preparation cost of dialkoxy magnesium is low, Said dialkoxy magnesium has good morphology, and its particle size distribution is even with small span. When the catalyst prepared by using such carrier is used for polymerization, the activity is high, and the obtained polymers have high bulk density, high isotacticity, good particle morphology, even distribution and low content of fine powders.

### DESCRIPTION OF DRAWING

FIG. 1 The photomicrograph of the dialkoxy magnesium carrier according to a example of the present invention;

FIG. 2 The photomicrograph of the carrier according to comparative example 1 of the present invention.

### EMBODIMENT

The present invention will be explained in detail by the following examples, which are not to restrict the scope of the present invention in any manner.

It should be noted that, the evaluation of magnesium compounds and polyolefins prepared in the examples are made by the following methods.
(1) The content of titanium in the catalyst is tested by 721 spectrophotometer;
(2) The isotactity (II) of the polymers is tested by the boiling n-heptane extraction method;
(3) The melt index of the polymers (MI) is tested according to testing standards GB/T3682-2000;
(4) The particle size and particle size distribution of the dialkoxy magnesium and the catalysts are tested by Malvern Mastcrsizer TM2000 laser diffraction method with n-hexane as a dispersant, wherein SPAN=(D₉₀−D₁₀)/D₅₀;
(5) The bulk density (BD) is tested by the method of the weight of loose solid in each unit volume;
(6) The content of ethylene is tested by ¹³C-NMR;
(7) The content of insoluble component in xylene (XS %) at room temperature is tested according to ISO 16152-2005;
(8) The content of the alkoxy group is tested by first acidolysis of the alkoxy magnesium carrier, then neutralizing the excess acid, and finally using the chromatography for test.

### Example 1

### (1) The Preparation of Dialkoxy Magnesium Carrier

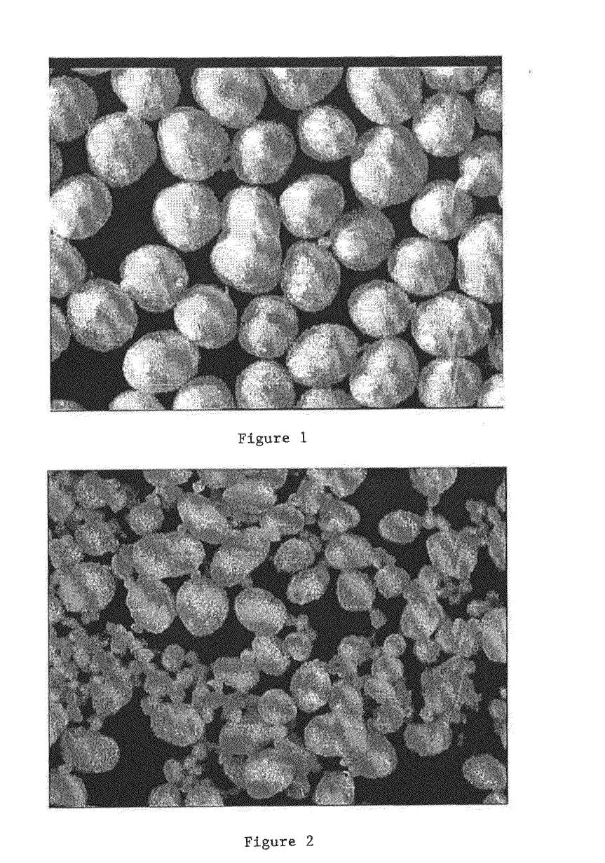

After the air in 16 L pressure-resistant reactor is fully replaced with nitrogen, 1.0000 ml of ethanol, 300 ml of 2-ethyl hexanol and 200 ml of isopropanol are added into the reactor, and 12 g of iodine and 8 g of magnesium chloride are also added to be dissolved. The temperature is increased after stirring to reach the reflux temperature of the reaction system. Then a total of 640 g of magnesium powders are successively added. The reaction is carried out until the reaction is completed, i.e. no hydrogen is discharged. Then the dialkoxy magnesium carrier 14 is obtained after being washed, separated and dried. The data are shown in Table 1. The photomicrograph is shown in FIG. 1.

### (2) The Preparation of the Catalyst Component

650 g of the above dialkoxy magnesium carrier 1#, 3250 ml of toluene and 65 ml of din-butyl phthalate (DNBP) are used to make to a suspension. 2600 ml of toluene and 3900 ml of titanium tetrachloride are added into a 161, pressure-resistant reactor after the gas therein is repeatedly replaced with high purity nitrogen. Then the temperature is decreased to −5° C., after which the above prepared suspension is added into the reactor. After the temperature is maintained for 1 h, the temperature is slowly increased up to 110° C., and 65 ml of DNBP is added when the temperature is increased to 80° C. The temperature is maintained at 110° C. for 2 h, and the liquid is removed by filtration under pressure. Then the mixed solution of 5070 ml of toluene and 3380 ml of titanium tetrachloride is added, and said mixed solution is used to treat the solid for 1 h under stirring when the temperature is increased to 110° C. Such treatment is repeated for 3 times before the liquid is removed by filtration. The obtained solid is washed with 150 ml of hexane for 4 times, then the liquid is removed by filtration, and then the solid catalyst component is obtained after being dried. The data are shown in Table 2.

### (3) The Olefin Polymerization

Propylene is used as said olefin, and is polymerized according to the following steps:

Into a 5 L steel autoclave equipped with a stirrer, after the air therein is replaced with nitrogen, 5 ml), of hexane solution of triethyl aluminium (the concentration of triethyl aluminium is 0.5 mmol/ml), 1 ml of hexane solution of cyclohexyl methyl dimethoxy silane (CHMMS) (the concentration of cyclohexyl methyl dimethoxy silane is 0.10 mmol/ml), 10 ml of anhydrous hexane and 10 mg of the solid catalyst component are introduced in nitrogen stream at room temperature. After the autoclave is closed, 4.5 L of hydrogen (in the standard state) and 2.0 L of liquid propylene are introduced. Then the temperature is increased to 70° C. in 10 min under stirring. After the polymerization is carried out at 70° C. for 1 h, the stirring is stopped, the unpolymerized propylene monomers are removed and the polymers are collected. The data are shown in Table 2.

### Example 2

Except that 10200 ml of ethanol is added in the preparation of a dialkoxy magnesium carrier, and isopropanol is not added, the other conditions are similar to those in Example 1. The data are shown in Tables 1 and 2.

### Example 3

Except that 10300 ml of ethanol is added in the preparation of the dialkoxy magnesium carrier, and 2-ethyl hexanol is not added, the other conditions are similar to those in Example 1. The data are shown in Tables 1 and 2.

### Example 4

Except that 10400 ml of ethanol and 100 ml of 2-ethyl hexanol are added in the preparation of the dialkoxy magnesium carrier, the other conditions are similar to those in Example 2. The data are shown in Tables 1 and 2.

### Example 5

Except that 10000 ml of ethanol and 500 ml of 2-ethyl hexanol are added in the preparation of the dialkoxy magnesium carrier, the other conditions are similar to those in Example 2. The data are shown in Tables 1 and 2.

### Example 6

Except that 6 g of iodine and 4 g of magnesium chloride are added in the preparation of a dialkoxy magnesium carrier, the other conditions are similar to those in Example 2. The data are shown in Tables 1 and 2.

### Example 7

Except that 2 g of iodine and 3 g of magnesium chloride are added in the preparation of the dialkoxy magnesium carrier, the other conditions are similar to those in Example 2. The data are shown in Table 1 and 2.

### Example 8

Except that the adding amount of ethanol, 2-ethyl hexanol and isopropanol in the preparation of the dialkoxy magnesium carrier are adjusted 10200 ml, 150 ml and 150 ml respectively, the other conditions are similar to those in Example 2. The data are shown in Tables 1 and 2.

### Example 9

Except that the 2-ethyl of hexanol is replaced with n-heptanol in the preparation of the dialkoxy magnesium carrier, the other conditions are similar to those in Example 2. The data are shown in Tables 1 and 2.

### Example 10

Except that the isopropanol is replaced with n-butanol in the preparation of the dialkoxy magnesium carrier, the other conditions are similar to those in Example 3. The data are shown in Tables 1 and 2.

### Example 11

### (1) The Preparation of the Dialkoxy Magnesium Carrier

It is similar to Example 1. The data are shown in Table 1.

### (2) The Preparation of the Catalyst Component

650 g of the above-mentioned dialkoxy magnesium carrier and 3250 ml of toluene are used to make to a suspension. 2600 ml of toluene and 3900 ml of titanium tetrachloride are added into a 16 L pressure-resistant reactor, after the air therein is repeatedly replaced with high purity nitrogen. After the temperature is decreased to −5° C., the above prepared suspension is added into the reactor. After the temperature is maintained for 1 h, the temperature is slowly increased up to 110° C., and 65 ml of DNBP is added when the temperature is increased to 80° C. The temperature is maintained at 110° C. For 2 h, and the liquid is removed by filtration under pressure. Then the mixed solution of 5070 ml of toluene and 3380 ml of titanium tetrachloride is added, and said mixed solution is used to treat the solid for 1 h under stirring when the temperature is increased to 110° C. Such treatment is repeated for 3 times, and the liquid is removed by filtration. The obtained solid is washed with 150 ml of hexane for 4 times, the liquid is removed by filtration, and the solid catalyst component is obtained after being dried. The data are shown in Table 2.

### (3) The Olefin Polymerization

The steps are similar to those in Example 1. The data are shown in Table 2.

### Example 12

### (1) The Preparation of the Dialkoxy Magnesium Carrier

It is similar to Example 1. The data are shown in Table 1.

### (2) The Preparation of the Catalyst Component

650 g of the above-mentioned dialkoxy magnesium carrier, 3250 ml of toluene and 182 ml of din-butyl phthalate (DNBP) are used to make to a suspension. 2800 ml of toluene and 3900 ml of titanium tetrachloride are added into a 16 L pressure-resistant reactor after the air therein is repeatedly replaced with high purity nitrogen. After the temperature is decreased to −5° C., the above prepared suspension is added into the reactor. After the temperature is maintained for 1 h, the temperature is slowly increased up to 110° C., and 130 ml of DNBP is added when the temperature is increased to 80° C. The temperature is maintained at 110° C. for 2 h, and the liquid is removed by filtration under pressure. Then the mixed solution of 5070 ml of toluene and 3380 ml of titanium tetrachloride is added, and said mixed solution is used to treat the solid for 1 h under stirring when the temperature is increased to 110° C. Such treatment is repeated for 3 times, and the liquid is removed by filtration. The obtained solid is washed with 150 ml of hexane for 4 times, then the liquid is removed by filtration, and then the solid catalyst component is obtained after being dried. The data are shown in Table 2.

### (3) The Olefin Polymerization

The step is similar to Example 1. The data are shown in Table 2.

### Comparative Example 1

### (1) The Preparation of the Dialkoxy Magnesium Carrier

After the air in a 161, pressure-resistant reactor is fully replaced with nitrogen, 13300 ml of ethanol is added into the reactor, and 23 g of iodine is also added. The temperature is increased after stirring to reach the reflux temperature of the reaction system. Then a total of 640 g of magnesium powders are successively added. The reaction is carried out until the reaction is completed, i.e. no hydrogen is discharged. Then the dialkoxy magnesium carrier is obtained after being washed, separated and dried. The data are shown in Table 1. The photomicrograph is shown in FIG. 2,

### (2) The Preparation of the Catalyst Component

Except that the dialkoxy magnesium carrier in the above step (1) is used, the others are similar to those in Example 1. The data are shown in Table 2.

### (3) The Olefin Polymerization

The steps are similar to those in Example 1. The data are shown in Table 2.

### Example 13

### (1) The Preparation of the Dialkoxy Magnesium Carrier

A 1 L reactor with a stirrer is equipped with a reflux condenser, a thermometer and a burette. After the air in the reactor is fully replaced with nitrogen, 550 ml of ethanol and 10 ml of isopropanol are added into the reactor, and 0.68 g of iodine and 0.42 g of magnesium chloride are also added to be dissolved. The temperature is increased after stirring to reach the reflux temperature of the reaction system. Then a total of 32 g of magnesium powders are successively added, and 90 ml of toluene is introduced. The reaction is carried out until the reaction is completed, i.e. no hydrogen is discharged. Then dialkoxy magnesium carrier is obtained after being washed, separated and dried. The data are shown in Table 1.

### (2) The Preparation of the Catalyst Component

10 g of the above dialkoxy magnesium carrier, 50 ml of toluene and 2.0 ml of 4-ethyl-3,5-heptanediol dibenzoate are used to make a suspension. 10 ml of toluene and 90 ml of titanium tetrachloride are added into the 300 ml reactor after the air therein is repeatedly replaced with high purity nitrogen. After the temperature is increased to 80° C., the above prepared suspension is added into the reactor. After the temperature is maintained for 1 h, the temperature is slowly increased up to 115° C.: and maintained for 2 h, and the liquid is removed by filtration under pressure. Then the mixed solution of 120 ml of toluene and 30 ml of titanium tetrachloride is added, and said mixed solution is used to treat the solid for 1 h under stirring when the temperature is increased to 110° C. Such treatment is repeated for 3 times, and the liquid is removed by filtration. The obtained solid is washed with 150 ml of hexane for 4 times, the liquid is removed by filtration, and the solid catalyst component is obtained after being dried. The data are shown in Table 2.

### (3) The Olefin Polymerization

The steps are similar to those in Example 1. The data are shown in Table 2.

### Example 14

Except that the 4-ethyl-3,5-heptanediol dibenzoate is replaced by 3,5-heptanediol dibenzoate in the preparation of the catalyst component, the others are similar to those in Example 13. The data are shown in Table 2.

### Example 15

Except that the 4-ethyl-3,5-heptanediol dibenzoate is replaced by 2,4-pentanediol dibenzoate in the preparation of the catalyst component, the others are similar to those in Example 13. The data are shown in Table 2.

### Example 16

### (1) The Preparation of the Dialkoxy Magnesium Carrier

It is similar to Example 13.

### (2) The Preparation of the Catalyst Component

10 ml of toluene and 90 ml of titanium tetrachloride are added into a 300 ml reactor after the air therein is repeatedly replaced with high purity nitrogen. The temperature is decreased to −5° C., and then the prepared suspension of 10 g of dialkoxy magnesium and 50 ml of toluene in Example 13 is added. After the temperature is slowly increased to 80° C., 1.8 ml of 4-ethyl-3,5-heptanediol dibenzoate is added. The temperature is increased up to 115° C. and maintained for 2 h, and the liquid is removed by filtration under pressure. Then the mixed solution of 120 ml of titanium tetrachloride and 30 ml of toluene is added, and said mixed solution is used to treat the solid for 1 h under stirring when the temperature is increased to 110° C. Such treatment is repeated for 3 times, and the liquid is removed by filtration. The obtained solid is washed with 150 ml of hexane for 4 times, the liquid is removed by filtration, and the solid catalyst component is obtained after being dried.

### (3) The Olefin Polymerization

The steps are similar to those in Example 13. The data are shown in Table 2.

### Example 17

Except that the 4-ethyl-3,5-heptanediol dibenzoate is replaced by 3,5-heptanediol dibenzoate in the preparation of the catalyst component, the others are similar to those in Example 16. The data are shown in Table 2.

### Example 18

Except that the 4-ethyl-3,5-heptanediol dibenzoate is replaced by 2,4-pentanediol dibenzoate in the preparation of the catalyst component, the others are similar to those in Example 13. The data are shown in Table 2.

### Example 19

### (1) The Preparation of the Dialkoxy Magnesium Carrier

A 1 L reactor with a stirrer is equipped with a reflux condenser, a thermometer and a burette. After the air in the reactor is fully replaced with nitrogen, 550 ml of ethanol and 10 ml of isopropanol are added into the reactor, and 0.08 g of iodine and 0.8 g of magnesium chloride are also added to be dissolved. The temperature is increased after stirring to reach the reflux temperature of the reaction system. Then a total of 32 g of magnesium powders are successively added, and 90 ml of toluene is introduced. The reaction is carried out until the reaction is completed, i.e. no hydrogen is discharged. Then the dialkoxy magnesium carrier is obtained after being washed, separated and dried. The data are shown in Table 1.

### (2) The Preparation of the Catalyst Component

The steps are similar to those in Example 13.

### (3) The Olefin Polymerization

The steps are similar to those in Example 13. The data are shown in Table 2.

### Example 20

### (1) The Preparation of the Dialkoxy Magnesium Carrier

A 1 L reactor with a stirrer is equipped with a reflux condenser, a thermometer and a burette. After the air in the reactor is fully replaced with nitrogen, 550 ml of ethanol and 10 ml of isopropanol are added into the reactor, and 2 g of iodine and 0.04 g of magnesium chloride are also added to be dissolved. The temperature is increased after stirring to reach the reflux temperature of the reaction system. Then a total of 32 g of magnesium powders are successively added, and 90 ml of toluene is introduced. The reaction is carried out until the reaction is completed, i.e. no hydrogen is discharged. Then the dialkoxy magnesium carrier is obtained after being washed, separated and dried. The data are shown in Table 1.

### (2) The Preparation of the Catalyst Component

The steps are similar to those in Example 13.

### (3) The Olefin Polymerization

The steps are similar to those in Example 13. The data are shown in Table 2.

### Example 21

### (1) The Preparation of the Dialkoxy Magnesium Carrier

A 1 L reactor with a stirrer is equipped with a reflux condenser, a thermometer and a burette. After the air in the reactor is fully replaced with nitrogen, 560 ml of ethanol and 50 ml of 2-ethyl hexanol are added into the reactor, and 2 g of iodine and 0.2 g of magnesium chloride are also added to be dissolved. The temperature is increased after stirring to reach the reflux temperature of the reaction system. Then a total of 32 g of magnesium powders are successively added, and 30 ml of toluene is introduced. The reaction is carried out until the reaction is completed, i.e. no hydrogen is discharged. Then the dialkoxy magnesium carrier is obtained after being washed, separated and dried. The data are shown in Table 1.

### (2) The Preparation of the Catalyst Component

The steps are similar to those in Example 1

### (3) The Olefin Polymerization

The steps are similar to those in Example 1. The data are shown in Table 2.

### Comparative Example 2

### (1) The Preparation of the Dialkoxy Magnesium Carrier

It is similar to Example 13.

### (2) The Preparation of the Catalyst Component

10 g of the above dialkoxy magnesium carrier, 50 ml of toluene and 2.5 ml of din-butyl phthalate (DNBP) are used to make to s suspension. 10 ml of toluene and 90 ml of titanium tetrachloride are added into a 300 ml reactor after the air therein is repeatedly replaced with high purity nitrogen. After the temperature is increased to 80° C., the above prepared suspension is added into the reactor. After the temperature is maintained for 1 h, the temperature is slowly increased up to 115° C. and maintained for 2 h, and the liquid is removed by filtration under pressure. Then the mixed solution of 120 ml of toluene and 30 ml of titanium tetrachloride is added, and said mixed solution is used to treat the solid for 1 h under stirring when the temperature is increased to 110° C. Such treatment is repeated for 3 times, and the liquid is removed by filtration. The obtained solid is washed with 150 ml hexane for 4 times, the liquid is removed by filtration, and the solid catalyst component is obtained after being dried. The data are shown in Table 2.

### (3) The Olefin Polymerization

The steps are similar to those in Example 13. The data are shown in Table 2.

### Comparative Example 3

### (1) The Preparation of the Catalyst Component

Into a reactor in which the gas is repeatedly replaced with high purity nitrogen, 4.8 g of anhydrous magnesium chloride, 100 ml of toluene, 4.0 ml of epichlorohydrin and 12.5 ml of tributyl phosphate are added. The reaction mixture is made to react for 2 h with a stirring speed of 450 rpm and a temperature of 60° C. 1.4 g of phthalic anhydride is added, and after the reaction is continued for 1 h, the temperature is decreased to −28° C. 56 ml of titanium tetrachloride is added and the temperate is increased slowly to 85° C., and 2.0 ml of 2,4-pentanediol dibenzoate is added at 80° C. When the temperature reaches 85° C., it is kept for 1 h. After the mother liquor is removed by filtration, the residual solid is first washed with 0.95 mol of toluene for 2 times, and then treated with 0.57 mol of toluene and 0.36 mol of titanium tetrachloride for 2 h at 110° C. Such treatment is repeated once again after filtration. The obtained solid is washed with hexane for 5 times and dried, and the solid titanium-containing catalyst component is obtained.

### (2) The Olefin Polymerization

The steps are similar to those in Example 13. The data are shown in Table 2.

TABLE 1
The data of dialkoxy magnesium carrier

| | | | Halogen atom/ | Alcohols/ | | 2-ethyl | Isopro- |
|---|---|---|---|---|---|---|---|
| | Halogenated | I₂:MgCl₂ | magnesium | magnesium | Ethanol | hexanol | panol |
| | agents | wt:wt | mol/mol | wt/wt | ml | ml | ml |
| Example 1 | I₂, MgCl₂ | 1.5:1 | 0.01:1 | 13.0:1 | 10000 | 300 | 200 |
| Example 2 | I₂, MgCl₂ | 1.5:1 | 0.01:1 | 13.0:1 | 10000 | 300 | 0 |
| Example 3 | I₂, MgCl₂ | 1.5:1 | 0.01:1 | 12.8:1 | 10000 | 0 | 200 |
| Example 4 | I₂, MgCl₂ | 1.5:1 | 0.01:1 | 13.0:1 | 10000 | 100 | 0 |
| Example 5 | I₂, MgCl₂ | 1.5:1 | 0.01:1 | 13.0:1 | 10000 | 500 | 0 |
| Example 6 | I₂, MgCl₂ | 1.5:1 | 0.005:1 | 13.0:1 | 10000 | 300 | 0 |
| Example 7 | I₂, MgCl₂ | 1:1.5 | 0.003:1 | 13.0:1 | 10000 | 300 | 200 |
| Example 8 | I₂, MgCl₂ | 1.5:1 | 0.01:1 | 13.0:1 | 10200 | 150 | 150 |
| Example 9 | I₂, MgCl₂ | 1.5:1 | 0.01:1 | 12.8:1 | 10000 | n-heptanol | 0 |
| | | | | | | 300 | |
| Example 10 | I₂, MgCl₂ | 1.5:1 | 0.01:1 | 13.0:1 | 10000 | 0 | n-butanol |
| | | | | | | | 200 |
| Example 11 | I₂, MgCl₂ | 1.5:1 | 0.01:1 | 13.0:1 | 10000 | 300 | 200 |
| Example 12 | I₂, MgCl₂ | 1.5:1 | 0.01:1 | 13.0:1 | 10000 | 300 | 200 |
| Example 13 | I₂, MgCl₂ | 1.6:1 | 0.011:1 | 13.8:1 | 550 | 0 | 10 |
| Example 19 | I₂, MgCl₂ | 0.1:1 | 0.013:1 | 13.8:1 | 550 | 0 | 10 |
| Example 20 | I₂, MgCl₂ | 1:0.02 | 0.012:1 | 13.8:1 | 530 | 20 | 10 |
| Example 21 | I₂, MgCl₂ | 1:0.1 | 0.015:1 | 15.1:1 | 560 | 50 | 0 |
| Comparative | I₂ | — | 0.0068:1 | 16.4:1 | 13300 | 0 | 0 |
| Example 1 | | | | | | | |
| Comparative | I₂ | — | 0.0018:1 | 16.4:1 | 13300 | 0 | 0 |
| Example 4 | | | | | | | |

| | Average | | Particle size | Bulk | Alkoxy magnesium wt % | |
|---|---|---|---|---|---|---|
| | particle size | toluene | distribution | density | 2-ethyl hexyl- | isopropoxy |
| | D₅₀ um | ml | SPAN | g/cm³ | oxy magnesium | magnesium |
| Example 1 | 79.6 | 0 | 0.67 | 0.39 | 1.5 | 1.2 |
| Example 2 | 76.8 | 0 | 0.68 | 0.37 | 1.8 | 0 |
| Example 3 | 69.3 | 0 | 0.73 | 0.35 | 0 | 1.5 |
| Example 4 | 65.2 | 0 | 0.77 | 0.35 | 0.7 | 0 |
| Example 5 | 82.5 | 0 | 0.63 | 0.38 | 3.8 | 0 |
| Example 6 | 39.6 | 0 | 0.82 | 0.37 | 1.7 | 0 |
| Example 7 | 25.8 | 0 | 0.81 | 0.28 | 1.6 | 1.1 |
| Example 8 | 72.2 | 0 | 0.75 | 0.36 | 1.0 | 1.2 |
| Example 9 | 66.2 | 0 | 0.85 | 0.34 | heptyloxy magnesium | |
| | | | | | 2.0 | |
| Example 10 | 56.6 | 0 | 0.76 | 0.32 | butoxy magnesium | |
| | | | | | 2.0 | |
| Example 11 | 76.8 | 0 | 0.65 | 0.39 | 1.5 | 1.2 |
| Example 12 | 76.8 | 0 | 0.65 | 0.39 | 1.5 | 1.2 |
| Example 13 | 43.0 | 90 | 0.73 | 0.40 | 0 | 1.6 |
| Example 19 | 38.5 | 90 | 1.03 | 0.37 | 0 | 1.5 |
| Example 20 | 81.7 | 60 | 0.86 | 0.42 | 1.9 | 1.2 |
| Example 21 | 30 | 83.5 | 0.91 | 0.42 | 5.2 | 0 |
| Comparative | 68.2 | 30 | 1.52 | 0.28 | 0 | 0 |
| Example 1 | | | | | | |
| Comparative | 26.3 | | 1.05 | 0.22 | 0 | 0 |
| Example 4 | | | | | | |

TABLE 2
The data of catalyst and polypropylene

| | item | | | | | | | | |
|---|---|---|---|---|---|---|---|---|---|
| | Catalyst component | | | | Propylene polymerization evaluation | | | | |
| | | Catalyst component | | | | | | | Polymer fine |
| | | Average | Particle size | | | | MI | | powders |
| | Ti | particle | distribution | Ac | | BD | (g/10 | II | <0.18 μm |
| No. | (wt %) | size D₅₀ | Span | (Kg/gcat) | MWD | (g/cm³) | min) | (%) | (%) |
| Example 1 | 2.55 | 75.3 | 0.66 | 70.5 | 6.92 | 0.438 | 27.9 | 97.1 | 0.2 |
| Example 2 | 2.62 | 72.2 | 0.68 | 68.9 | 6.32 | 0.435 | 26.3 | 97.0 | 0.2 |
| Example 3 | 2.34 | 64.4 | 0.72 | 61.1 | 5.82 | 0.420 | 23.2 | 96.2 | 0.4 |
| Example 4 | 2.38 | 62.6 | 0.82 | 65.8 | 6.21 | 0.433 | 22.5 | 96.7 | 0.5 |
| Example 5 | 2.81 | 77.9 | 0.73 | 66.7 | 6.50 | 0.427 | 25.11 | 96.6 | 0.2 |
| Example 6 | 2.56 | 36.8 | 0.80 | 62.6 | 6.31 | 0.412 | 23.72 | 96.1 | 0.3 |
| Example 7 | 2.23 | 23.7 | 0.83 | 71.1 | 6.03 | 0.443 | 25.2 | 96.5 | 0.4 |
| Example 8 | 2.61 | 69.6 | 0.74 | 64.3 | 6.21 | 0.428 | 25.6 | 96.3 | 0.3 |
| Example 9 | 2.90 | 63.7 | 0.82 | 60.2 | 6.38 | 0.425 | 23.4 | 96.2 | 0.5 |
| Example 10 | 2.36 | 53.9 | 0.72 | 65.7 | 6.35 | 0.432 | 22.8 | 97.0 | 0.4 |
| Example 11 | 2.88 | 69.3 | 0.86 | 66.3 | 6.18 | 0.426 | 24.11 | 95.8 | 0.8 |
| Example 12 | 2.25 | 57.1 | 1.07 | 58.9 | 6.22 | 0.423 | 23.63 | 95.5 | 0.8 |
| Example 13 | 2.73 | 39.9 | 0.73 | 68.3 | 7.70 | 0.448 | 29.40 | 96.7 | 0.3 |
| Example 14 | 2.64 | 41.2 | 0.74 | 63.7 | 7.60 | 0.449 | 25.30 | 97.1 | 0.3 |
| Example 15 | 2.82 | 37.1 | 0.85 | 62.0 | 7.90 | 0.441 | 18.85 | 97.8 | 0.5 |
| Example 16 | 2.91 | 33.3 | 1.05 | 65.8 | 7.40 | 0.442 | 31.22 | 96.2 | 0.2 |
| Example 17 | 2.80 | 37.5 | 0.92 | 62.9 | 7.30 | 0.430 | 26.43 | 97.0 | 0.3 |
| Example 18 | 2.86 | 36.7 | 0.95 | 59.3 | 7.50 | 0.43 | 19.64 | 97.5 | 0.4 |
| Example 19 | 2.98 | 37.1 | 0.98 | 55.5 | 6.56 | 0.446 | 27.2 | 96.1 | 1.0 |
| Example 20 | 2.23 | 79.8 | 0.87 | 66.1 | 6.23 | 0.442 | 23.5 | 97.0 | 0.5 |
| Example 21 | 2.57 | 77.6 | 0.89 | 66.1 | 5.95 | 0.433 | 24.3 | 96.5 | 0.5 |
| Comparative | 2.43 | 60.5 | 1.45 | 48.1 | 5.65 | 0.409 | 19.62 | 96.2 | 1.7 |
| Example 1 | | | | | | | | | |
| Comparative | 2.33 | 38.8 | 0.79 | 55.2 | 5.20 | 0.443 | 21.15 | 96.7 | 0.6 |
| Example 2 | | | | | | | | | |
| Comparative | 2.43 | 22.5 | 1.15 | 56.0 | 6.50 | 0.451 | 20.32 | 97.5 | 0.7 |
| Example 3 | | | | | | | | | |

It can be seen from the data in Table 2, the catalyst obtained in the present invention has a high polymerization activity, a low content of polymer fine powders, a wide molecular weight distribution, and good isotactic and melt indexes. The polymers have good processing performances.

Examples about Propylene-Ethylene Block Copolymers

### Example 22

### (1) The Preparation of a Dialkoxy Magnesium Carrier

It is similar to Example 1.

### (2) The Preparation of a Catalyst Component

The steps are similar to those in Example 1.

### (3) The Olefin Polymerization

The propylene and ethylene are used as said olefin, and are polymerized according to the following steps:

In a 5 L steel autoclave equipped with a stirrer, the air is fully replaced with nitrogen, which is then replaced with propylene, and then 5 ml of hexane solution of triethyl aluminium (the concentration of triethyl aluminium is 0.5 mmol/ml), 0.5 ml of hexane solution of disopropyl dimethoxy silane (DIPDMS) (the concentration of DIPDMS is 0.10 mmol/ml), 10 ml of anhydrous hexane and 10 mg of solid catalyst component are introduced at room temperature. The pressure is increased by hydrogen to 1.2 MPa, and then 2.0 L of liquid propylene is added. The temperature is increased to 70° C. under stirring, and the polymerization is carried out at 70° C. for 1 h.

Then the stirring is stopped, the air is slowly emptied, and hot water is feed into the jacket at the same time to increase the temperature to 80° C. When the pressure in the reactor is decreased to 1.0 MPa, the stir is started, and then the emptying and warming operation proceed slowly. When the temperature reaches 80° C., the pressure in the reactor is emptied to 0 MPa (gauge pressure). Then 1.0 MPa of (gauge pressure) ethylene gas/propylene gas are feed in with a molar ratio of 3.2:6.8, and the propylene-ethylene copolymerization is carried out at 80° C. and 1.0 MPa for 1 h. The pressure is released to the atmospheric pressure, and the temperature is decreased to room temperature. Then the reactor is opened, and the produced polymer particles are recovered. The results are shown in Table 3.

### Example 23

Except that the molar ratio of ethylene to propylene in the second step is changed to 5.3:4.7, the others are similar to those in Example 11. The data are shown in Table 3.

### Comparative Example 4

### (1) The Preparation of the Dialkoxy Magnesium Carrier

After the air in a 16 L pressure-resistant reactor equipped with a stirrer is fully replaced with nitrogen, 13300 ml of ethanol and 6 g of iodine are added into the reactor. The temperature is increased after stirring to reach the reflux temperature of the reaction system. Then a total of 640 g of magnesium powders are successively added. The reaction is carried out until the reaction is completed, i.e. no hydrogen is discharged. Then the dialkoxy magnesium carrier is obtained after being washed, separated and dried. The data are shown in Table 1.

### (2) The Preparation of a Catalyst Component

Except that the above dialkoxy magnesium (1) is used, the other steps are similar to those in Example 1. The content of Ti is 2.42 wt %, the average particle size is 25.1 μm and SPAN is 1.01 in the obtained catalyst.

### (3) The Olefin Polymerization

The steps are similar to those in Example 23. The data are shown in Table 3.

TABLE 3
Polymerization Data

| | | | Example | Example | Comparative |
|---|---|---|---|---|---|
| process | item | unit | 22 | 23 | Example 4 |
| First step | Polymerization time | min | 60 | 60 | 60 |
| | Polymerization | ° C. | 70 | 70 | 70 |
| | temperature | | | | |
| | Hydrogen pressure | MPa | 1.2 | 1.2 | 1.2 |
| | Total pressure | MPa | 3 | 3 | 3 |
| | Silicon compound | kind | DIPDMS | DIPDMS | DIPDMS |
| Second step | Polymerization time | min | 60 | 60 | 60 |
| | Polymerization | ° C. | 80 | 80 | 80 |
| | temperature | | | | |
| | C₂:C₃ | mol/mol | 3.2:6.8 | 5.3:4.7 | 5.3:4.7 |
| | Total pressure | MPa | 1 | 1 | 1 |
| | Polymerization | KgPP/gC at | 6.65 | 6.92 | 5.28 |
| | activity | | | | |
| | MI | g/10 min | 5.52 | 6.26 | 7.02 |
| | XS | wt % | 13.50 | 15.77 | 17.62 |
| | C₂ | mol % | 15.32 | 19.53 | 16.30 |

It can be seen from Table 3 that, the copolymers with a high ethylene content can be obtained with a low content of ethylene raw gas by using the catalyst provided by the present invention. The copolymerization performances of said catalyst are good, and the application prospect is good.

1-29. (canceled)

30. A solid catalyst component for olefin polymerization, comprising the reaction products of spherical dialkoxy magnesium carrier, titanium compounds and electron donor compounds in an inert solvent, wherein said dialkoxy magnesium carrier is the product prepared by the reflux reaction of magnesium, mixed alcohols and mixed halogenated agents in an inert atmosphere, in which said mixed halogenated agents are iodine and magnesium chloride, and said electron donor compounds are selected from did ester compounds as shown in Formula (I): 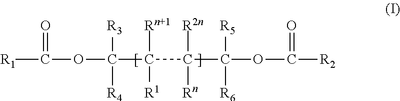
wherein, R₁-R₆ and R¹-R²ⁿ groups, the same with or different from each other, can be hydrogen atom, halogen atom, substituted or unsubstituted straight chain or branched chain C₁-C₂₀ alkyl, C₃-C₂₀ cycloalkyl, C₆-C₂₀ aryl, C₇-C₂₀ alkaryl, C₇-C₂₀ aralkyl, C₂-C₁₀ alkenyl, C₁₀-C₂₀ fused ring aryl or ester group; R₁ and R₂ are not hydrogen atoms; R₃-R₆ and R¹-R²ⁿ groups can optionally comprise one or more heteroatoms as the substituent of carbon and/or hydrogen atom, in which said heteroatoms are selected from nitrogen, oxygen, sulfur, silicon, phosphorus and halogen atoms, and one or more of R₃-R₆ and R¹-R²ⁿ groups can optionally form a ring with each other; and, n is an integer selected from 0 to 10.

31. The solid catalyst component according to claim 30, wherein said electron donor compounds are selected from the diol ester compounds as shown in Formula (II) 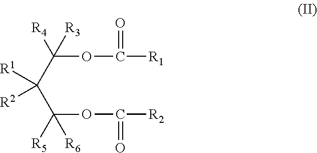
wherein R₁-R₆ and R¹-R² groups, the same with or different from each other, can be the hydrogen atom, the halogen atom, straight chain or branched chain C₁-C₂₀ alkyl, C₃-C₂₀ cycloalkyl, C₆-C₂₀ aryl, C₇-C₂₀ alkaryl or C₇-C₂₀ aralkyl group.

32. The solid catalyst component according to claim 30, wherein said electron donor compounds comprise at least one of C₁-C₄ alkyl esters of saturated aliphatic carboxylic acids, C₇-C₈ alkyl esters of aromatic carboxylic acids, C₂-C₆ aliphatic ethers, C₃-C₄ cycloethers, and C₃-C₆ saturated aliphatic ketones.

33. The solid catalyst component according to claim 30, wherein the weight ratio of said iodine to magnesium is 0.05:1 to 1:0.01,
preferably, the weight ratio of iodine to magnesium is 0.1:1 to 1:0.02.

34. The solid catalyst component according to claim 30, wherein said mixed alcohols comprise ethanol and at least one selected from C₆-C₁₁ alcohols,
preferably said mixed alcohols comprise ethanol and at least one selected from C₆-C₈ alcohols,
more preferably, said mixed alcohols is ethanol and 2-ethyl hexanol, and in said carrier, the content of ethoxy magnesium is equal to or higher than 80 wt %, and the content of 2-ethyl hexyloxy magnesium is 0.01 to 20 wt %.

35. The solid catalyst component according to claim 30, wherein said mixed alcohols comprise ethanol and at least one selected from C₁-C₅ lower alcohols, said lower alcohol containing no ethanol,
preferably, said mixed alcohols comprise ethanol and isopropanol, and in said carrier, the content of ethoxy magnesium is equal to or higher than 80 wt %, and the content of isopropoxy magnesium is 0.01 to 20 wt %.

36. The solid catalyst component according to claim 30, wherein said mixed alcohols comprise ethanol, at least one selected from C₆-C₁₁ alcohols and at least one selected from C₁-C₅ lower alcohols, said lower alcohols containing no ethanol,
preferably, said mixed alcohols comprise ethanol, 2-ethyl hexanol and isopropanol, and in said carrier, the content of ethoxy magnesium is equal to or higher than 80 wt %, the content of 2-ethyl hexyloxy magnesium is 0.01 to 19.9 wt % and the content of isopropoxy magnesium is 0.01 to 19.9 wt %.

37. The solid catalyst component according to claim 30, wherein the weight ratio of said alcohols and magnesium is 4:1 to 50:1, and the molar ratio of said magnesium and the halogen atoms in said mixed halogenated agents is 1:0.0002 to 1:0.2,
preferably, the weight ratio of said alcohols and magnesium is 6:1 to 25:1, and the molar ratio of said magnesium and the halogen atoms in said mixed halogenated agent is 1:0.001 to 1:0.08.

38. The solid catalyst component according to claim 30, wherein the average particle size of dialkoxy magnesium is 5 to 150 μm, and the particle size distribution index SPAN is less than 1.1,
preferably, the average particle size of dialkoxy magnesium is 8 to 100 μm, and the particle size distribution index SPAN is less than 1.05.

39. The solid catalyst component according to claim 30, wherein based on per molar of dialkoxy magnesium compounds, the dosage of titanium compounds is 0.5 to 100 mol, the dosage of electron donor compounds is 0.005 to 10 mol, and the dosage of said inert diluents is 0.5 to 100 mol,
preferably, based on per molar of dialkoxy magnesium compounds, the dosage of titanium compounds is 1 to 50 mol, the dosage of electron donor compounds is 0.01 to 1 mol, and the dosage of said inert diluents is 1 to 50 mol.

40. A catalyst for olefin polymerization comprising:
a) said solid catalyst component according to claim 30;
b) organo-aluminum compound, selected from at least one of the compounds as shown in Formula AlRₙX₃₋ₙ wherein R is selected from the hydrogen atom and C₁-C₂₀ hydrocarbyl group, X is the halogen atom, and n is an integer selected from higher than 0 to 3;
c) optional organo-silicon compounds with a formula of R₁R₂Si(OR′)₂, wherein R₁ and R₂, the same with or different from each other, can be C₁-C₂₀ alkyl, cycloalkyl or aryl group, and R′ is C₁-C₄ alkyl group.

41. A dialkoxy magnesium carrier, the product prepared by the reflux of magnesium, mixed alcohols and mixed halogenated agents under an inert atmosphere, said mixed halogenated agents comprising iodine and magnesium chloride, and said mixed alcohols comprising ethanol and 2-ethyl hexanol.

42. The carrier according to claim 41, wherein said mixed alcohols comprising mixture of ethanol, 2-ethyl hexanol and isopropanol.

43. The carrier according to claim 41, wherein the weight ratio of said iodine to magnesium is 0.05:1 to 1:0.01, preferably 0.1:1 to 1:0.02.

44. The carrier according to claim 41, wherein the content of ethoxy magnesium is equal to or higher than 80 wt %, and the content of 2-ethyl hexyloxy magnesium is 0.01 to 20 wt %.

45. The carrier according to claim 42, wherein the content of ethoxy magnesium is equal to or higher than 80 wt %, the content of 2-ethyl hexyloxy magnesium is 0.01 to 19.9 wt % and the content of isopropoxy magnesium is 0.01 to 19.9 wt %.

46. The carrier according to claim 41, wherein the weight ratio of said alcohols and magnesium is 4:1 to 50:1, and the molar ratio of said magnesium and the halogen atoms in said mixed halogenated agents is 1:0.0002 to 1:0.2,
preferably, the weight ratio of said alcohols and magnesium is 6:1 to 25:1, and the molar ratio of said magnesium and the halogen atoms in said mixed halogenated agents is 1:0.001 to 1:0.08.

47. The carrier according to claim 41, wherein the average particle size of dialkoxy magnesium is 5 to 150 μm, and the particle size distribution index SPAN is less than 1.1,
preferably, the average particle size of dialkoxy magnesium is 8 to 100 μm, and the particle size distribution index SPAN is less than 1.05.
